(19) United States
(12) Patent Application Publication
(10) Pub. No.: US 2015/0076825 A1
(43) Pub. Date: Mar. 19, 2015

(54) INLINE ELECTRIC GENERATOR WITH MAGNETICALLY SUSPENDED AXIAL FLOW OPEN CENTER IMPELLER

(71) Applicant: Magnetar Electric Technologies, LLC, Greenville, TX (US)

(72) Inventors: William T. Wyatt, II, Greenville, TX (US); Justin M. Wyatt, Greenville, TX (US)

(21) Appl. No.: 14/489,238

(22) Filed: Sep. 17, 2014

Related U.S. Application Data
(60) Provisional application No. 61/879,043, filed on Sep. 17, 2013.

(51) Int. Cl. H02K 7/18; H02K 3/46; H02K 1/27

(52) U.S. Cl. CPC H02K 7/1823; H02K 1/2706; H02K 3/46
USPC 290/52

(57) ABSTRACT

An electric power generator for placement inline with a conduit comprises a substantially cylindrical housing defining a non-magnetic elongated chamber configured to be coupled to the conduit so that a fluid flowing in the conduit flows through the elongated chamber, an impeller defining a central channel disposed in the elongated chamber and an inner surface of the central channel having a plurality of blade members shaping fluid flow in the central channel, where the impeller further including a matrix of permanent magnets secured to an exterior surface wall. The generator further comprises a copper coil assembly coupled to the substantially cylindrical housing and comprising a plurality of copper coils arranged circumferentially about the cylindrical housing, and configured to interact with the matrix of permanent magnets to generate electricity when the impeller rotates due to fluid flowing in the central channel and acting on the blade members.

### RELATED APPLICATION

The present application claims the benefit of U.S. Provisional Patent Application No. 61/879,043 filed on Sep. 17, 2013, incorporated herein by reference in its entirety.

### BACKGROUND

Climate change and geopolitical concerns continue to focus our need for sources of green or renewable energy. Currently the largest investments in this technology are being made in the fields of solar and Wind technologies. Hydropower, with essentially no emissions, currently accounts for only about 7% of the electricity produced in the United States. However, these projects, including Hydropower, Pumped Storage or Run-of-River facilities, are generally very large, costly and take years of environmental impact studies, construction, licensing and regulations and have enormous long term maintenance costs making them less appealing than other forms of renewable energy.

Today energy costs and consumption are primary concerns globally. Every industrial nation is currently searching for new innovative technology to reduce consumption, emissions, and costs while taking advantage of available resources that do not negatively affect the environment.

There have been many attempts to capture the existing energy in closed loop fluid and gas systems, but all attempts use existing technologies and install in the pipe some form of paddle wheel, impeller with support bearings and/or shafts, or other mechanical means that is coupled to an electric generator to capture the kinetic energy that exists within the pipe. These mechanical systems are very inefficient, only capturing about 12-19% of the potential energy that exists within the pipe. Due to these inefficiencies and the high costs of the equipment needed to generate this energy relative to the value of energy created, there have been no designs developed for practical low cost-effective applications of these systems.

Therefore, there is currently a need in the art for a method and system of generating electricity from closed loop fluid or gas systems with optimal efficiency to capture the potential energy in these systems while remaining cost-effective and environmentally friendly.

### BRIEF SUMMARY OF THE INVENTION

An electric power generator for placement inline with a conduit comprises a substantially cylindrical housing defining an elongated chamber configured to be coupled to the conduit so that a fluid flowing in the conduit flows through the elongated chamber, an impeller defining a central channel disposed in the elongated chamber and an inner surface of the central channel having a plurality of blade members shaping fluid flow in the central channel, where the impeller further including a matrix of permanent magnets secured to an exterior surface wall. The generator further comprises a copper coil assembly coupled to the substantially cylindrical housing and comprising a plurality of copper coils arranged circumferentially about the cylindrical housing, and configured to interact with the matrix of permanent magnets to generate electricity when the impeller rotates due to fluid flowing in the central channel and acting on the blade members.

An electric power generator for placement inline with a conduit comprises a housing defining an elongated chamber configured to be coupled to the conduit so that a fluid flowing in the conduit flows through the elongated chamber, an impeller defining a central channel configured to be magnetically-suspended in the elongated chamber, the central channel defining a plurality of spiral blade members configured for shaping fluid flow in the central channel, and a copper coil assembly coupled to the housing and having a plurality of copper coils arranged circumferentially about the housing, and configured to generate electricity in response to a rotational motion of the impeller within the elongated chamber.

An electric power generator for placement inline with a conduit comprises an impeller defining a central channel configured to be magnetically-suspended in the conduit, the central channel defining a plurality of spiral blade members configured for shaping fluid flow in the central channel, and a copper coil assembly coupled to the conduit and having a plurality of copper coils arranged circumferentially about the conduit, and configured to generate electricity in response to a rotational motion of the impeller within the conduit.

### BRIEF DESCRIPTION OF THE DRAWINGS

A more complete appreciation of the invention, features and many of the attendant advantages of the various embodiments thereof will be readily obtained as the same becomes better understood by reference to the following detailed descriptions when considered in connection with the accompanying drawings in which like numbers refer to like parts throughout, and in which:

FIG. 1A is a side view of an exemplary embodiment of an inline electric generator attached to a fluid conduit having an array of copper coils placed outside the conduit according to the teachings of the present disclosure;

FIG. 1B is a cross-sectional view of an exemplary embodiment of an inline electric generator attached to a fluid conduit having an array of copper coils placed outside the conduit according to the teachings of the present disclosure;

FIG. 1C is a cross-sectional partial view of an exemplary embodiment of an inline electric generator attached to a fluid conduit having an array of copper coils placed outside the conduit according to the teachings of the present disclosure;

FIG. 2A is a side view of an exemplary embodiment of a magnetically suspended axial flow open center impeller with axially formed internal impeller blades according to the teachings of the present disclosure;

FIG. 2B is a cross-sectional view of an exemplary embodiment of a magnetically suspended axial flow open center impeller with axially formed internal impeller blades according to the teachings of the present disclosure;

FIG. 2C is an end view of an exemplary embodiment of a magnetically suspended axial flow open center impeller with axially formed internal impeller blades according to the teachings of the present disclosure;

FIG. 2D is a perspective view of an exemplary embodiment of a magnetically suspended axial flow open center impeller with axially formed internal impeller blades according to the teachings of the present disclosure;

FIG. 3A is a side view of an exemplary embodiment of an electric generator non-magnetic copper coil mounting assembly according to the teachings of the present disclosure;

FIG. 3B is a perspective view of an exemplary embodiment of an electric generator non-magnetic copper coil mounting assembly according to the teachings of the present disclosure;

FIG. 3C is a top view of an exemplary embodiment of an electric generator non-magnetic copper coil mounting assembly according to the teachings of the present disclosure;

FIGS. 4A-4C are various views of an exemplary embodiment of a coil mount for the noon-magnetic copper coil mounting assembly according to the teachings of the present disclosure;

FIG. 5 is a perspective view of an exemplary embodiment of an impeller assembly showing the exterior wall surface for receiving permanent magnets according to the teachings of the present disclosure; and

FIG. 6 is a simplified schematic diagram of an exemplary embodiment of an inline electric generator according to the teachings of the present disclosure.

### DETAILED DESCRIPTION AND BEST MODE OF IMPLEMENTATION

Referring now to the accompanying drawings, wherein like reference numerals designate identical or corresponding parts throughout the several views, there is illustrated an embodiment of an inline electric generating system for use in generating electricity, primarily from the kinetic energy in flowing pressurized fluids in a conduit. Other applications and embodiments are contemplated herein. As will become clear from the following description, the system embodies a number of distinct benefits over the related art, in particular a broad field of in-pipe applications, improved reliability, improved efficiency, lower costs to produce, very low maintenance and a lighter weight construction.

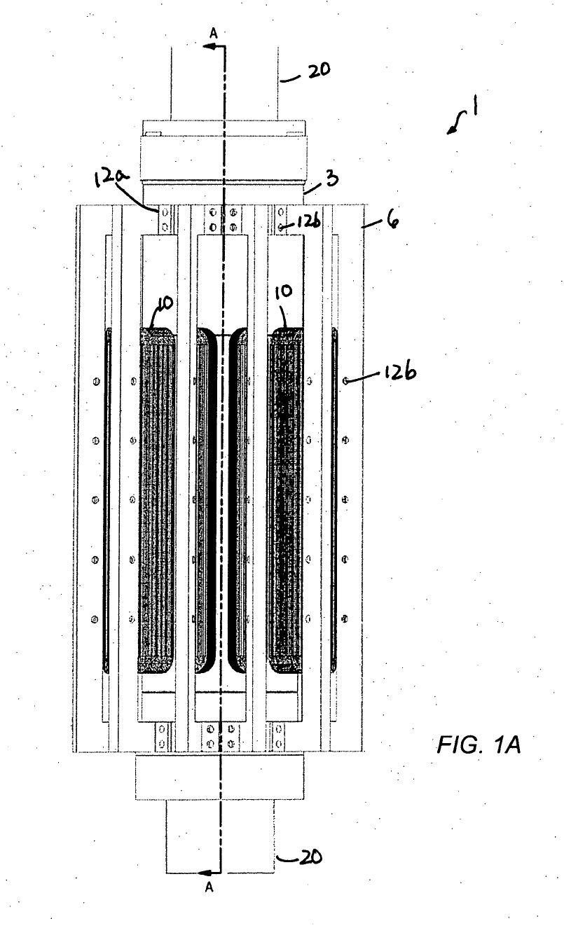

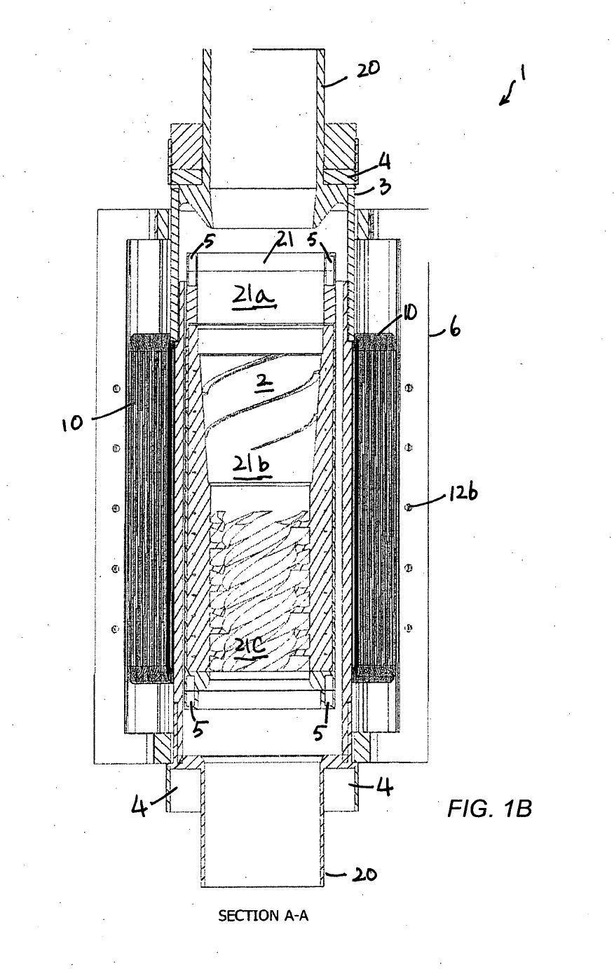

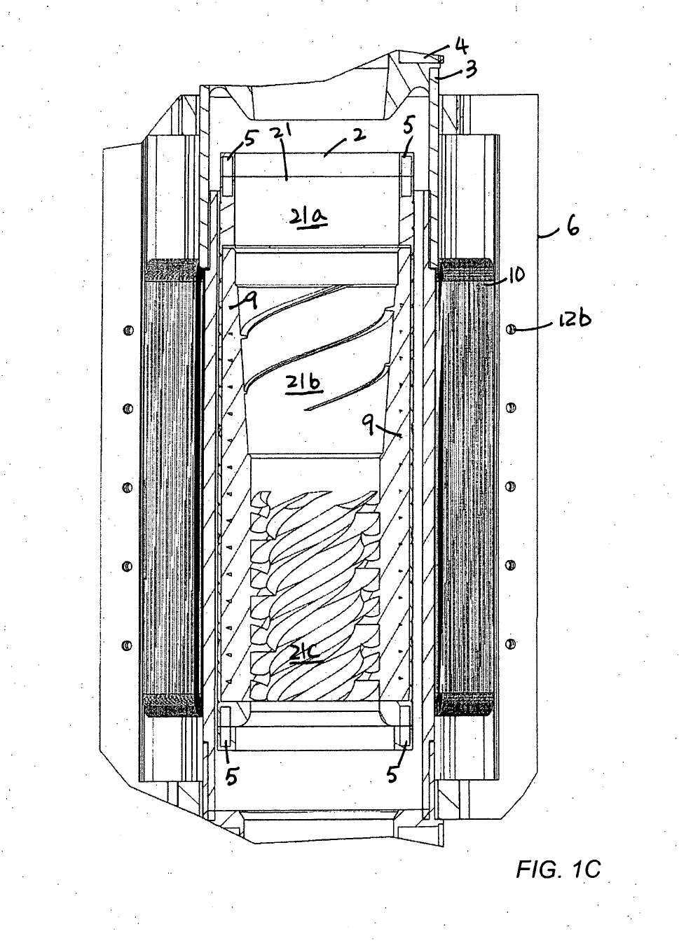

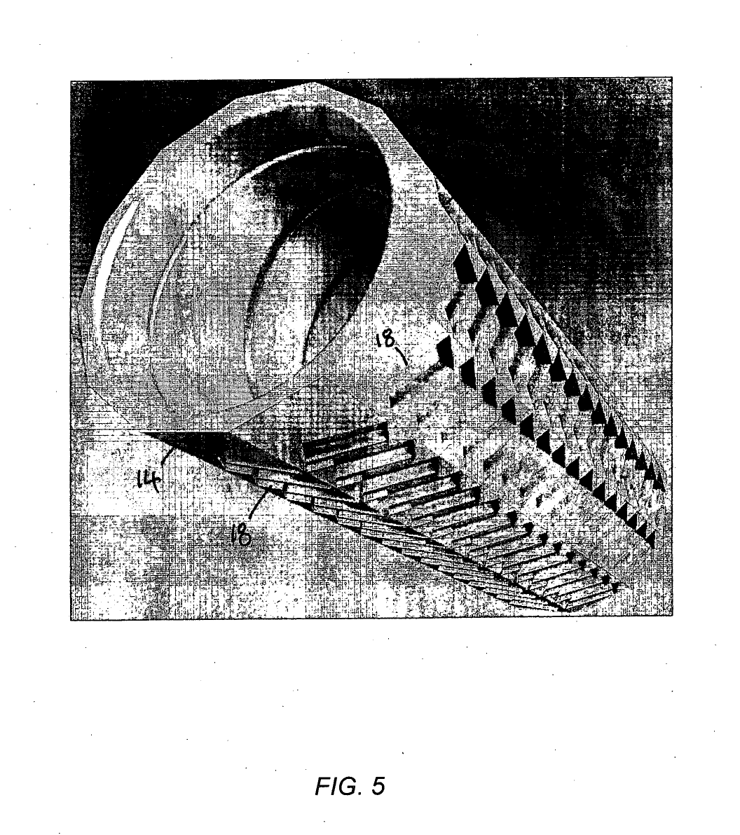

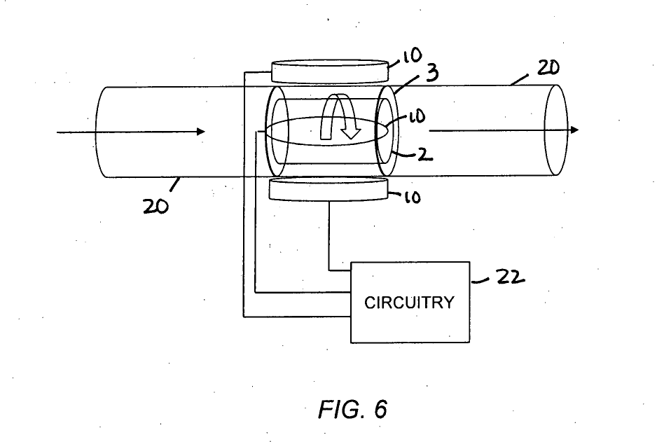

Referring to FIGS. 1A, 1B, and 5, the inline electric generating system 1 is generally configured for placement inline of a conduit 20 conducting a flowing fluid (gas and/or liquid). The system 1 generally includes a non-magnetic generally cylindrical housing 3 with a wall that defines an inner cylindrical elongated chamber 21 (21a-21c) for accommodating a magnetically suspended axial flow open center impeller assembly 2. The impeller assembly 2 is generally cylindrical with a central fluid flow conductive channel. The conduit 20, cylindrical housing 3, and impeller assembly 2 are co-axially aligned (sharing a common longitudinal center axis). The impeller assembly 2 defines an interior surface of the central fluid flow conductive channel that includes a plurality of blade members that interact with the fluid flowing in the channel, causing the impeller to rotate. A plurality of magnets are embedded in the exterior wall of the impeller assembly 2. A copper coil assembly having a plurality of copper coils is affixed to the exterior of the cylindrical housing 3. When the fluid flows in the conduit to the cylindrical housing 3 and through the central conductive channel of the impeller assembly 2, the forces of the fluid causes the impeller assembly 2 to rotate within the chamber, and the rotation of the embedded magnets induces an electric current in the copper coils of the copper coil assembly. The generated electric current is collected by a power circuitry 22, which may supply the generated electricity to the power grid, to a bank of batteries, and other power systems.

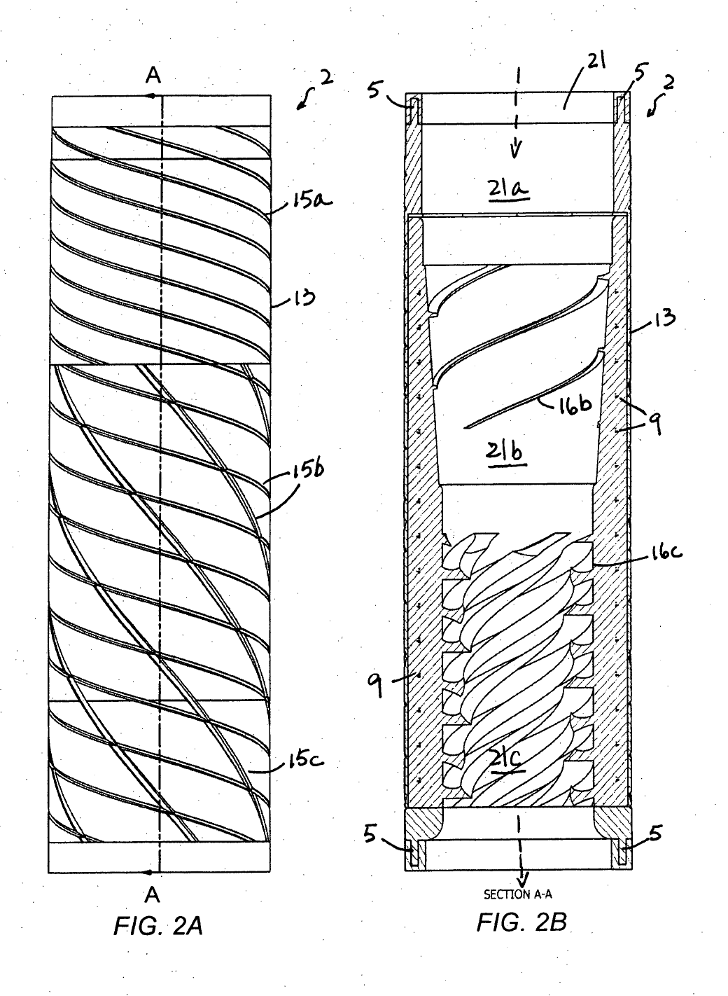

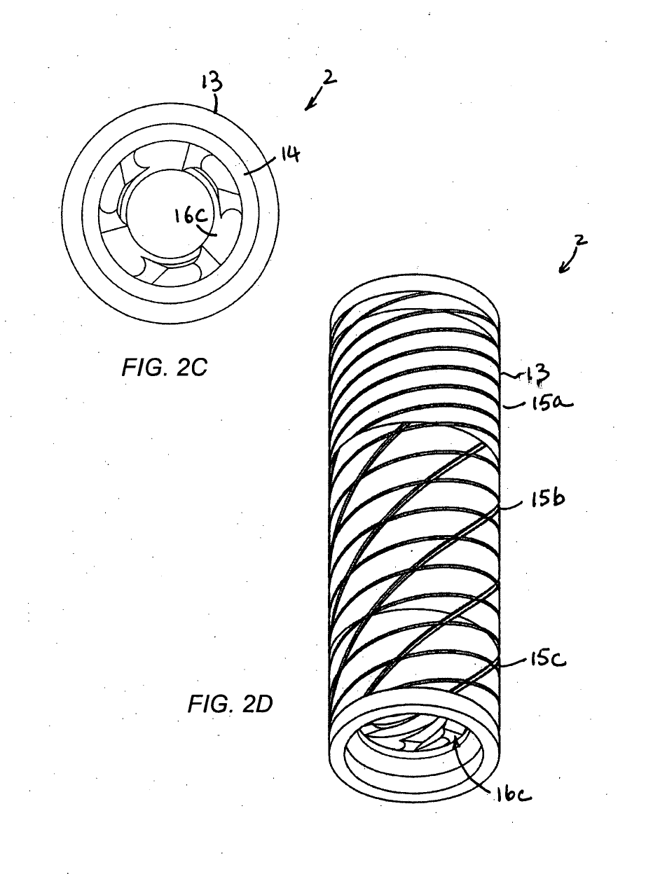

Continuing to refer to FIGS. 1A-1C, more details of the inline electric generating system 1, with a magnetically suspended axial flow open center impeller assembly 2 (shown in FIGS. 2A-2D), are shown. In this embodiment, the inline electric generating system 1 comprises a non-magnetic cylindrical housing 3 to which permanent ring magnets 4 are affixed at each end of the non-magnetic cylindrical housing 3 with a specific magnetic north and south orientation. The axial flow open center impeller assembly 2 comprises an array of permanent magnets 5 disposed at both ends thereof, which interacts with the permanent ring magnets 4 to cause the impeller assembly 2 to counteract the pull of gravity and flow of the fluid to magnetically levitate within a defined area of the cylindrical housing 3 between the two permanent ring magnets 4. As used herein the term “permanent ring magnet” or “permanent magnet” shall mean an object made from a material that is magnetized and creates its own persistent magnetic field. Some non-limiting examples of magnetic material include hard ferromagnetic materials such as alnico and ferrite.

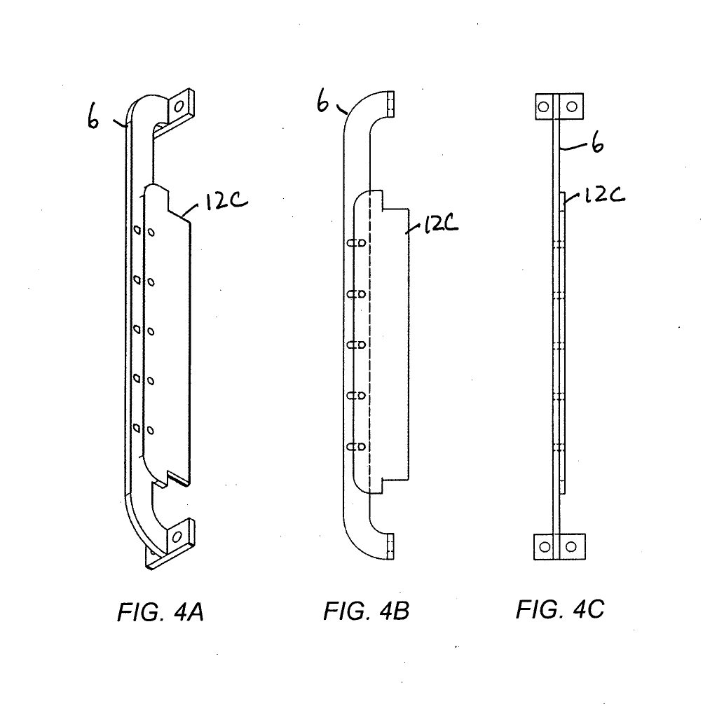

As best seen in FIG. 2B, the impeller assembly 2 comprises a generally cylindrical impeller 14 with an impeller housing cover 13. The impeller housing cover 13 has an exterior surface formed with patterns of grooves 15a-15c defined thereon. Like the different blade patterns in the central conductive channel of the impeller, the groove patterns may also vary along the length of the housing cover. A primary function of the grooves 15a-15c is to provide for and/or increase the stability of the impeller assembly 2 as it rotates inside the cylindrical housing 3. Additionally, the impeller 14 comprises a plurality of permanent magnets 9 (the recesses 18 to receive the permanent magnets 9 are shown in FIG. 4) affixed axially to the exterior surface of the impeller 14. The impeller housing cover 13 protects the permanent magnets from exposure to the fluids flowing inside the conduit. The permanent magnets 9 generate and encourages maximum rotational magnetic field potential from the rotation of the impeller assembly 2.

The generally cylindrical impeller 14 comprises an inner wall surface that generally defines a central fluid flow conductive channel that have successively smaller diameters (or circumference), shown as segments 21a, 21b, and 21c in FIG. 2B. As fluids enter from one end of the cylindrical housing and the center of the impeller 14, the conductive channel defined by the impeller 14 becomes increasingly smaller and more constricted. The smaller conductive channel causes the flow of the fluids to increase in flow rate and thus increase the efficiency of the system.

The impeller 14 interior wall surface comprises a plurality of axially formed blade members 16 (16b and 16c) that define spiral fluid flow channels within the impeller central conductive channel. In a preferred embodiment, the blade members in segments 21a, 21b, and 21c of the impeller 14 are preferably different in numbers, shape, angles, and overall configuration, and may serve different functions. The decreasing dimensions of the central conductive channel and the spiral fluid flow channel configurations work together to increase the efficiency of electricity generation by the system. As shown in FIG. 2B, segment 21a has an absence of blade members, segment 21b has gently spiraling blade members, and segment 21c has blade members with aggressive angles, surfaces, and orientation relative to the direction of fluid flow.

In a preferred embodiment of the impeller 14, the impeller may be formed by injection molding, 3D printing, or other suitable manufacturing methods. In these methods, the blade members are formed integral to the rest of the impeller. In other manufacturing methods, the impeller and the blade members may be formed from distinct pieces fastened together.

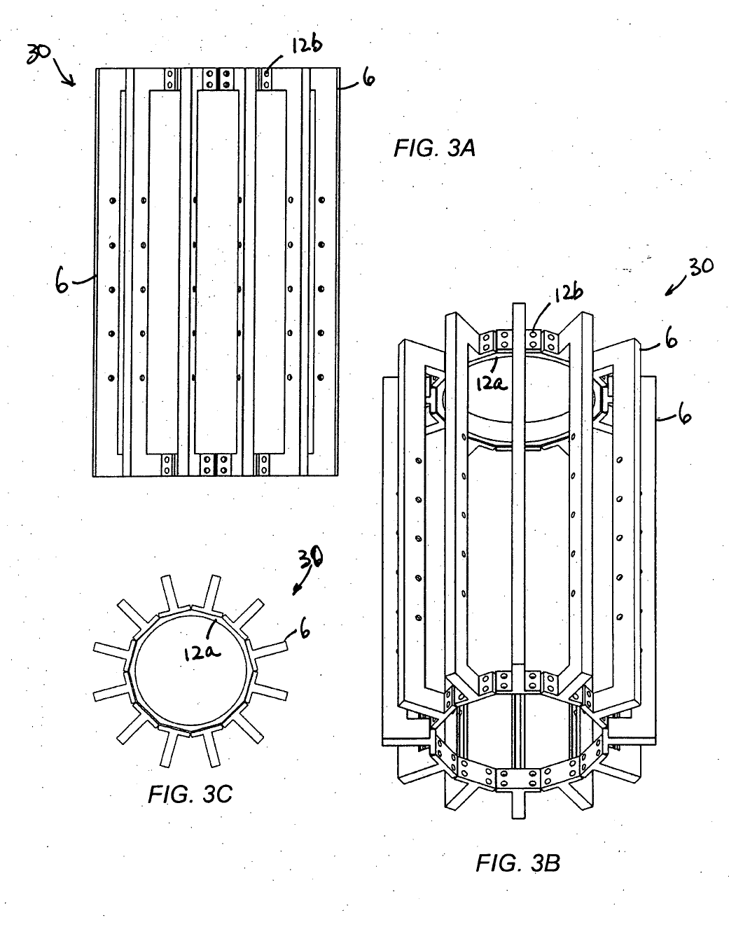

FIGS. 3A-3C are various views of an exemplary embodiment of an electric generator non-magnetic copper coil mounting assembly 30 according to the teachings of the present disclosure. In one embodiment of a non-magnetic copper coil mounting assembly 30 (shown in FIGS. 1A and 3A-3C), there is an array 11 of individual copper coils 10. Each coil 10 is affixed to a non-magnetic coil mount 12c (shown in FIGS. 4A-4C) and affixed to a non-magnetic coil support frame 6, then secured with non-magnetic threaded bolts 12b to a non-magnetic mounting ring 12a. The non-magnetic mounting ring 12a is externally affixed to the conduit for the purpose of holding the copper coils 10 in a fixed position with respect to the non-magnetic cylindrical housing unit 3, and affixed to the conduit.

The fluid circulating in the conduit acts on (i.e. comes in contact with and induces rotation of) the magnetically suspended axial flow open center impeller assembly 2 located within the conduit and between the two permanent ring magnets 4 affixed at each end of the non-magnetic housing 3 affixed to the conduit. The rotational movement of the magnetically suspended axial flow open center impeller assembly 2 induces an electric current in each of the individual externally affixed copper coils 10. The copper coils 10 are connected in such a manner 11 as to produce maximum electric current generated in the rotational magnetic field.

The features of the present disclosure which are believed to be novel are set forth below with particularity in the appended claims. However, modifications, variations, and changes to the exemplary embodiments described above will be apparent to those skilled in the art, and the inline electric generator described herein thus encompasses such modifications, variations, and changes and are not limited to the specific embodiments described herein.

What is claimed is:

1. An electric power generator for placement inline with a conduit, comprising:
a substantially cylindrical housing defining a non-magnetic elongated chamber configured to be coupled to the conduit so that a fluid flowing in the conduit flows through the elongated chamber;
an impeller defining a central channel disposed in the elongated chamber and an inner surface of the central channel having a plurality of blade members shaping fluid flow in the central channel;
the impeller further including a matrix of permanent magnets secured to an exterior surface wall; and
a copper coil assembly coupled to the substantially cylindrical housing and comprising a plurality of copper coils arranged circumferentially about the cylindrical housing, and configured to interact with the matrix of permanent magnets to generate electricity when the impeller rotates due to fluid flowing in the central channel and acting on the blade members.

2. The generator of claim 1, wherein the substantially cylindrical housing comprises a permanent ring magnet at each end thereof, the impeller comprises at least one permanent magnet at each end thereof, and the magnets interact to magnetically suspend the impeller within the non-magnetic elongated chamber of the substantially cylindrical housing.

3. The generator of claim 1, wherein the central channel of the impeller comprises an inlet and an outlet, a width of the central channel decreasing from the inlet to the outlet.

4. The generator of claim 1, wherein the central channel of the impeller comprises more than one segment, each segment defining a different configuration of blade members.

5. The generator of claim 4, further comprising an exterior impeller cover configured to overlay an exterior surface of the impeller.

6. The generator of claim 1, wherein the impeller is constructed from a non-magnetic material.

7. An electric power generation system for placement inline with a conduit, comprising:
a housing defining a non-magnetic elongated chamber configured to be coupled to the conduit so that a fluid flowing in the conduit flows through the elongated chamber;
an impeller defining a central channel configured to be magnetically-suspended in the elongated chamber, the central channel defining a plurality of spiral blade members configured for shaping fluid flow in the central channel; and
a copper coil assembly coupled to the housing and having a plurality of copper coils arranged circumferentially about the housing, and configured to generate electricity in response to a rotational motion of the impeller within the elongated chamber.

8. The power generation system of claim 7, wherein the housing comprises a permanent ring magnet at each end thereof, the impeller comprises at least one permanent magnet at each end thereof, and the magnets interact to magnetically suspend the impeller within the non-magnetic elongated chamber of the substantially cylindrical housing.

9. The power generation system of claim 7, wherein the central channel of the impeller comprises an inlet and an outlet, a diameter of the central channel decreasing gradually from the inlet to the outlet.

10. The power generation system of claim 7, wherein the central channel of the impeller comprises an inlet and an outlet and more than one segment from the inlet to the outlet, each segment having a decreasing diameter from the inlet to the outlet.

11. The power generation system of claim 7, wherein the central channel of the impeller comprises more than one segment, the central channel of each segment defining a different configuration of blade members.

12. The power generation system of claim 7, further comprising an exterior impeller cover configured to overlay an exterior surface of the impeller.

13. An electric power generator for placement inline with a conduit, comprising:
an impeller defining a central channel configured to be magnetically-suspended in the conduit, the central channel defining a plurality of spiral blade members configured for shaping fluid flow in the central channel; and
a copper coil assembly coupled to the conduit and having a plurality of copper coils arranged circumferentially about the conduit, and configured to generate electricity in response to a rotational motion of the impeller within the conduit.
